(19) United States
(12) Patent Application Publication
(10) Pub. No.: US 2024/0024819 A1
(43) Pub. Date: Jan. 25, 2024

(54) Catalytic Devices for the Abatement of NH3 and Nox Emissions From Internal Combustion Engines

(71) Applicant: Umicore AG & Co. KG, Hanau-Wolfgang (DE)

(72) Inventors: Massimo Colombo, Hanau-Wolfgang (DE); Michael Seyler, Mainaschaff (DE); Anke Schuler, Niedernberg (DE); Michelle Bendrich, Hanau-Wolfgang (DE)

(21) Appl. No.: 18/256,370

(22) PCT Filed: Dec. 3, 2021
(86) PCT No.: PCT/EP2021/084091

§ 371 Date: Jun. 7, 2023

(30) Foreign Application Priority Data
Dec. 14, 2020 (EP) 20213804.6

(51) Int. Cl. B01D 53/94; B01J 29/76; B01J 23/42; B01J 21/06; B01J 37/00; B01J 21/04; B01J 35/00; B01J 37/02; F01N 3/20; F01N 3/28; F01N 13/00

(52) U.S. Cl. CPC B01D 53/9472; B01D 53/9418; B01D 53/9436; B01D 53/9477; B01D 53/944; B01J 29/763; B01J 23/42; B01J 21/063; B01J 37/0018; B01J 21/04; B01J 35/0006; B01J 37/0215; F01N 3/2066; F01N 3/2825; F01N 13/009; B01D 2251/2062; B01D 2258/012; B01D 2257/404; B01D 2257/406; B01D 2257/708; B01D 2257/502; B01D 2257/702; B01D 2255/9032; B01D 2255/9022; B01D 2255/1021; B01D 2255/20761; B01D 2255/50; B01D 2255/20738; B01J 2229/183; F01N 2510/068; F01N 2370/04; F01N 2510/063; F01N 2610/02; F01N 2610/1453

(57) ABSTRACT

Disclosed is a catalytic device for the removal of nitrogen oxides and ammonia from the exhaust gas of lean-burn combustion engines, comprising an upstream SCR catalyst comprising a carrier substrate, and a first washcoat comprising a first SCR catalytically active composition SCRfirst and optionally at least one first binder, wherein the first washcoat is applied to the carrier substrate; and a downstream ASC catalyst comprising a carrier substrate, and a bottom layer comprising a third washcoat comprising an oxidation catalyst and optionally at least one third binder, said bottom layer being applied directly onto the carrier substrate, and a top layer comprising a second washcoat comprising a second SCR catalytically active composition SCRsecond and optionally at least one second binder and, said top layer being applied onto the bottom layer; wherein the upstream SCR catalyst and the downstream ASC catalyst are present on a single carrier substrate or on two different carrier substrates, and the first and the second SCR catalytically active compositions are the same or different from one another, and the optionally comprised at least one first, second and third binders are the same or different from one another, the ratio (AA) of the loadings of the first and the second SCR catalytically active compositions, given in g/L, in the first and the second washcoat is 1.2:1 to 2:1. The first and second SCR catalytically active compositions preferably comprise a molecular sieve, and the oxidation catalyst preferably comprises a platinum group metal. The catalytic device can be used for the removal of nitrogen oxides and ammonia from the exhaust gas of lean-burn combustion engines.

The present invention refers to catalytic devices for the abatement of NH₃ and NOₓ emissions from internal combustion engines, in particular of lean operated engines, like diesel engines, and to methods for making said catalytic devices, and to their use in exhaust aftertreatment systems.

Modern internal combustion engines require the use of catalytic aftertreatment systems to reduce harmful emissions and respect the new legislation standards.

In addition to carbon monoxide CO, hydrocarbons HC, and nitrogen oxides NOₓ, the raw exhaust gas of diesel engines contains a relatively high oxygen content of up to 15 vol %. Particle emissions that predominantly consist of soot residues and possibly organic agglomerates and originate from a partially incomplete fuel combustion in the cylinder of the engine, are contained as well.

While diesel particulate filters with and without a catalytically-active coating are suitable for removing particle emissions, carbon monoxide and hydrocarbons are rendered harmless by oxidation on a suitable oxidation catalyst. Oxidation catalysts are described extensively in the literature. They are, for example, flow-through substrates, which carry precious metals, such as platinum and palladium, as essential, catalytically-active components on large-area, porous, high-melting oxides, such as aluminum oxide.

Nitrogen oxides may be converted on an SCR catalyst in the presence of oxygen to nitrogen and water by means of ammonia. SCR catalysts are described extensively in literature as well. They are generally either so-called mixed oxide catalysts, which contain, in particular, vanadium, titanium, and tungsten, or so-called zeolite catalysts, which comprise a metal-exchanged, in particular small pore zeolite. SCR-catalytically-active materials may be carried on flow-through substrates or on wall-flow filters.

The ammonia used as reducing agent may be made available by feeding an ammonia precursor compound into the exhaust gas which is thermolyzed and hydrolyzed to form ammonia. Examples of such precursors are ammonium carbamate, ammonium formate and preferably urea. Alternatively, the ammonia may be formed by catalytic reactions within the exhaust gas.

In order to improve the conversion of nitrogen oxides at the SCR catalyst, it may be necessary to feed in the ammonia in a quantity that is approximately 10 to 20% higher than the quantity required, i.e., in a overstoichiometric quantity. This in turn leads to unreacted ammonia in the exhaust gas, which is undesirable in view of its toxic effects. Ammonia emissions are increasingly limited in the exhaust gas legislation.

To avoid ammonia emissions, so called ammonia slip catalysts (ASC) have been developed. These catalysts usually comprise an oxidation catalyst for the oxidation of ammonia at temperatures as low as possible. Such oxidation catalysts comprise at least one precious metal, preferably a platinum group metal (PGM), like for example palladium and, in particular, platinum. However, oxidation catalysts comprising precious metals oxidize ammonia not only to nitrogen (N₂) but also to harmful species like dinitrogen oxide (N₂O) and nitrogen oxides (NOₓ) as well. The oxidation of NH₃ to nitrogen, N₂O, NO or NO₂, respectively, is shown in equations (1) to (4):

4NH₃+3O₂→2N₂+6H₂O (1)

6NH₃+6O₂→3N₂O+9H₂O (2)

4NH₃+5O₂→4NO+6H₂O (3)

4NH₃+7O₂→4NO₂+6H₂O (4)

The selectivity of the ammonia oxidation towards nitrogen can be improved by combining the oxidation catalyst with an SCR catalyst. Such combination can be performed in different ways, for example both components can be mixed and/or they can each be present in a separate layer on a carrier substrate. In case of a layered arrangement, the SCR layer is usually the upper layer and is coated on the oxidation layer which is the lower layer. ASC catalysts are usually coated on a monolithic carrier substrate like a flow through substrate or a wall flow filter.

In order to achieve high NOₓ conversions, high amounts of active SCR material are needed within the ASC. On the other hand, a high amount of SCR material covering the PGM component would significantly reduce its ammonia conversion activity. Thus, there is a need to solve this trade-off.

US 2015/151288 A1 discloses a catalyst composition comprising a zeolite having the CHA framework, a molar silica-to-alumina ratio (SAR) of at least 40, and an atomic copper-to-aluminum ratio of at least 1.25. The copper-CHA zeolite can also be used to promote the oxidation of ammonia. Thus, the copper-CHA zeolite can be formulated to favor the oxidation of ammonia with oxygen, particularly at concentrations of ammonia typically encountered downstream of an SCR catalyst (e.g. ammonia oxidation (AMOX) catalyst, such as an ammonia slip catalyst (ASC)). In this embodiments, the catalyst can be disposed as a top layer over an oxidation under-layer, wherein the under-layer comprises a platinum-group metal (PGM) catalyst or a non-PGM catalyst. The catalyst component in the under-layer is preferably supported on a high surface area support, for example on alumina. In other embodiments, the SCR catalyst, which is the copper-CHA according to US 2015/181288 A1, can be disposed on the upstream side of a wall-flow filter, and the ammonia slip catalyst is disposed on the outlet side of said filter. In another embodiment, the SCR catalyst is disposed on the upstream side of a flow-through substrate, and the ASC catalyst is disposed on its downstream side. Furthermore, the SCR catalyst and the ASC catalyst can be disposed on separate bricks adjacent to, and in contact with one another, provided that the SCR catalyst brick is disposed upstream of the ammonia slip catalyst brick.

WO 2016/160953 A1 discloses a catalyzed particulate filter comprising at least three coatings creating at least two zones axially along the porous walls of the filter, wherein a first coating is a first SCR catalyst coating, a second coating is a second SCR catalyst coating, and a third coating is a platinum group metal coating. The platinum group metal coating can be sandwiched between the first and the second SCR catalyst coating. Alternatively, the filter may comprise at least three zones, wherein the first SCR catalyst is present in the first, upstream zone, the second SCR catalyst is present in the middle zone, and the PGM group is present in the third, downstream zone, wherein the zones are arranged adjacent to one another. Furthermore, in another embodiment, the first SCR catalyst is present in an upstream zone, and the second SCR catalyst and the platinum group metal catalyst are intermingled in a downstream zone. The first and the second SCR catalyst are selected, independently from one another, from zeolites, preferably AEI, AFX and CHA. The zeolites are promoted with a transition metal, preferably with copper or iron. Suitable washcoat concentrations of the first and the second SCR catalyst and the platinum group metal catalyst are given. However, WO 2016/160953 A1 is silent about the ratios of the washcoat concentrations.

WO 2017/037006 A1 discloses an integrated SCR and ammonia oxidation catalyst. The catalyst comprises a first washcoat zone including copper or iron on a small-pore molecular sieve, the first washcoat zone being substantially free of platinum group metal; and a second washcoat zone including copper or iron on a small-pore molecular sieve mixed with platinum on a refractory metal oxide support including alumina, silica, zirconia, titania and mixtures and combinations of said refractory metal oxides. The first washcoat zone is located upstream of the second washcoat zone. In the second zone, platinum or a mixture of platinum and rhodium are present in an amount of 3 to 20 g/ft³ each, corresponding to 0,106 to 0,706 g/L. The zeolites are promoted with Cu or Fe, preferably Cu, in an amount of 0.1 to 10 wt.-%, pref. 0.1 to 5 wt.-%, calculated as CuO. However, WO 2017/037006 A1 is silent about suitable washcoat concentrations of the zeolite in the two zones, and it also silent about concentration ratio of the zeolites in the first and the second zone, respectively.

WO 2010/062730 A2 discloses a catalyst system including an upstream zone effective to catalyze the conversion of a mixture of NOₓ and NH₃ to N₂, and a downstream zone effective for the conversion of ammonia to N₂. The upstream and the downstream zone may be present on one single monolith, or they may be present on two adjacent monoliths. The catalyst for converting a mixture of NOₓ and NH₃ to N₂, which is an SCR catalyst, is a silicoaluminate or silicoaluminophosphate zeolite. Preferably, the zeolite is selected from the framework types FAU, MFI, MOR, BEA and CHA. The zeolite is promoted with a transition metal, preferably with copper or iron. The catalyst effective for the conversion of ammonia to N₂, which is an ammonia oxidation catalyst, abbreviated as AMOX, comprises a precious metal component selected from ruthenium, rhodium, iridium, palladium, platinum, silver, gold and mixtures thereof. Optionally, the NH₃ oxidation composition may contain a component active for the ammonia SCR function.

The AMOX catalyst is present as an undercoat layer, and the SCR catalyst is present as an overcoat layer. If both the SCR and the AMOX catalyst are present on a single monolithic substrate, both catalysts cover at least 5 up to 100% each of the entire monolith length each, and the overcoat overlays at least a part of the undercoat.

The washcoat comprising the NH₃ oxidation composition is applied onto the monolith first, thus forming the undercoat layer. Afterwards, the SCR catalyst composition is applied in such a way that it overlays at least a part of the undercoat as described above. Thus, the layer thickness resp. the washcoat loading of the SCR catalyst in the upstream zone and thickness resp. the washcoat loading of the SCR catalyst overlaying the NH3 oxidation composition are the same.

Optionally, the monolith can be coated with multiple layers of an SCR catalyst composition over its entire length. In embodiments wherein the SCR function and the NH₃ oxidation function are present on the same monolith, the ratio of the front zone length, which comprises the SCR function, to the total substrate length is at least 0.4, preferably 0.5 to 0.9, and most preferably 0.6 to 0.8.

As mentioned above, in an alternative embodiment of WO 2016/062730 A2, the catalyst system is a “bifunctional catalyst” with physically separate compositions for the SCR function and the NH₃ oxidation function. Such modular catalyst system permit greater flexibility to independently tune the kinetics of the two functions. However, is not disclosed as to how this tuning of the kinetics of the two functions has to be carried out.

WO 2018/183457 A1 discloses a catalytic article for treating an exhaust gas stream containing particulate matter, hydrocarbons, carbon monoxide and ammonia, the article may include: (a) a substrate having an inlet end and an outlet end defining an axial length; (b) a first catalyst coating including: 1) a platinum group metal distributed on a molecular sieve, and 2) a base metal distributed on a molecular sieve; and (c) a second catalyst coating including: 1) a platinum group metal distributed on a molecular sieve, and 2) a base metal distributed on a molecular sieve. The platinum group metal preferably is platinum, palladium, or a combination thereof. The molecular sieve can be a small-pore, medium-pore or large-pore zeolite. Preferably, the molecular sieve is a small-pore zeolite, most preferably, it is selected from CHA, LEV, AEI, AFX, ERI, LTA, SFW, KFI, DDR and ITE. The base metal preferably is copper, iron, or a mixture thereof. Thus, the first and the second catalyst coating both comprise an ammonia slip catalyst (ASC or AMOX) as well as a selective catalytic reduction (SCR) catalyst). The higher the PGM loading in one of the layers, the higher is the ASC activity in said layer. On the other hand, the lower the PGM loading in one of the layers, the more selective the ASC reactivity. The higher the selectivity in the ASC layer, the more the formation of N₂ is preferred over the formation of N₂O, NO and NO₂, see equations (1) to (4) above. According to WO 2018/183457 A1, the two catalyst layers can be arranged on top of one another, wherein “on top” means that the upper layer totally covers the bottom layer, or that it only covers a part of the lower layer. In all cases, the bottom layer shall have a higher ASC activity, and the top layer shall have a higher ASC selectivity than the respective other layer. This can be achieved by adjusting the PGM loading: in the various embodiments of WO 2018/183457 A1, the PGM loading in the top layer is lower than or equal to the PGM loading in the bottom layer. Suitable numerical ranges for the PGM loadings of the top and the bottom layers, respectively, are given. However, WO 2018/183457 A1 is silent about the loadings of the SCR catalysts. The ASC catalysts can be combined with an upstream SCR functionality. Said SCR functionality can be located upstream and the ASC functionality downstream on the same monolith, or the SCR functionality can be located on a separate monolith.

WO 2018/057844 A1 discloses an ammonia slip catalyst (ASC) comprising a first SCR catalyst, an oxidation catalyst comprising ruthenium or a ruthenium mixture, such as a platinum and ruthenium mixture, on a support comprising a rutile phase and a substrate. The SCR catalyst can be a small-pore, medium-pore or large-pore molecular sieve, preferably promoted with copper or iron, or the SCR catalyst can be a base metal or an oxide of a base metal, for example vanadium or a vanadium oxide. Ruthenium on rutile based supports shall offer superior N₂O selectivity compared to platinum based ammonia slip catalysts. Furthermore, ruthenium on rutile catalysts offer increases stability over ruthenium supported on non-rutile structured supports as well as a better activity. Lower N₂O selectivity in NH₃-slip applications can occur while retaining high activity along with improved stability over other ruthenium based catalysts. The ammonia slip catalyst may comprise an SCR catalyst and an oxidation catalyst admixed with one another. The ammonia slip catalyst may also be located on a substrate, and at least a portion of a second SCR catalyst is located over at least a portion of the ASC. In another embodiment, the ammonia slip catalyst can be a bi-layer having a top layer of the first SCR catalyst and a bottom layer comprising the oxidation catalyst. In yet another embodiment, an ASC catalyst is a bi-layer with a top layer comprising a first SCR catalyst and a bottom layer comprising the oxidation catalyst, and a second SCR catalyst is located both adjacent to, and completely covering, the ASC layer, as shown in FIG. 21 referring back to FIG. 16. However, WO 2018/057844 A1 is silent about suitable loadings of the SCR catalysts.

There is a constant need for improved ASC catalysts showing both a good activity for converting ammonia, but also a good selectivity, meaning that as much ammonia as possible is converted to nitrogen according to equation (1) above, but not to N₂O, NO, or NOₓ according to equations (2), (3), and (4).

### Problem to be Solved by the Invention

It is an object of the present invention to provide catalytic devices for the removal of nitrogen oxides and ammonia from the exhaust gas of lean-burn combustion engines which show a high conversion rate of nitrogen oxides to nitrogen and also a good activity as well as a good selectivity for converting ammonia into nitrogen. Another object of the present invention is to provide a system for the treatment of exhaust gases of lean-burn combustion engines which comprise the catalytic devices according to the present invention.

### Solution of the Problem

The object to provide catalytic devices for the removal of nitrogen oxides and ammonia from the exhaust gas of lean-burn combustion engines which show a high conversion rate of nitrogen oxides to nitrogen and also a good activity as well as a good selectivity for converting ammonia into nitrogen is solved by catalytic devices for the removal of nitrogen oxides and ammonia from the exhaust gas of lean-burn combustion engines, comprising:
(a) an upstream SCR catalyst comprising
   (i) a carrier substrate, and
   (ii) a first washcoat comprising a first SCR catalytically active composition SCR_{first} and optionally at least one first binder, wherein the first washcoat is applied to the carrier substrate,
(b) a downstream ASC catalyst comprising
   (i) a carrier substrate, and
   (ii) a bottom layer comprising a third washcoat comprising an oxidation catalyst and optionally at least one third binder, said bottom layer being applied directly onto the carrier substrate, and
   (iii) a top layer comprising a second washcoat comprising a second SCR catalytically active composition SCR_{second} and optionally at least one second binder, said top layer being applied onto the bottom layer,
wherein
   the upstream SCR catalyst and the downstream ASC catalyst are present on a single carrier substrate or on two different carrier substrates, and
   the first and the second SCR catalytically active compositions are the same or different from one another, and
   the optionally comprised at least one first, second and third binders are the same or different from one another,
   the ratio

$$\frac{{SCR}_{first}}{{SCR}_{second}}$$

of the loadings of the first and the second SR catalytically active compositions, given in g/L, in the first and the second washcoat is 1.2:1 to 2:1.

It has surprisingly been found that the combination of a) a high conversion rate of nitrogen oxides to nitrogen and also b) a good activity as well as c) a good selectivity for converting ammonia into nitrogen depends on the ratio

$$\frac{{SCR}_{first}}{{SCR}_{second}}$$

of the loadings of the first and the second SCR catalytically active compositions.

The catalytic devices for the removal of nitrogen oxides from the exhaust gas of lean-burn combustion engines and the system for the treatment of exhaust gases of lean-burn combustion engines comprising said catalytic devices from exhaust gas of lean combustion engines and the method for its manufacture are explained below, with the invention encompassing all the embodiments indicated below, both individually and in combination with one another.

“Upstream” and “downstream” are terms relative to the normal flow direction of the exhaust gas in the exhaust pipeline. A “zone or catalyst 1 which is located upstream of a zone or catalyst 2” means that the zone or catalyst 1 is positioned closer to the source of the exhaust gas, i.e. closer to the motor, than the zone or catalyst 2. The flow direction is from the source of the exhaust gas to the exhaust pipe. Accordingly, in this flow direction the exhaust gas enters each zone or catalyst at its inlet end, and it leaves each zone or catalyst at its outlet end.

A “catalyst carrier substrate”, also just called a “carrier substrate” is a support to which the catalytically active composition is affixed and shapes the final catalyst. The carrier substrate is thus a carrier for the catalytically active composition.

A “catalytically active composition” is a substance or a mixture of substances which is capable to convert one or more components of an exhaust gas into one or more other components. An example of such a catalytically active composition is, for instance, an oxidation catalyst composition which is capable of converting volatile organic compounds and carbon monoxide to carbon dioxide or ammonia to nitrogen oxides. Another example of such a catalyst is, for example, a selective reduction catalyst (SCR) composition which is capable of converting nitrogen oxides to nitrogen and water. In the context of the present invention, an SCR catalyst is a catalyst comprising a carrier substrate and a washcoat comprising an SCR catalytically active composition. An ammonia slip catalyst (ASC) is a catalyst comprising a carrier substrate, a washcoat comprising an oxidation catalyst, and a washcoat comprising an SCR catalytically active composition.

A “washcoat” as used in the present invention is an aqueous suspension of a catalytically active composition and optionally at least one binder. Materials which are suitable binders are, for example, aluminum oxide, titanium dioxide, silicon dioxide, zirconium dioxide, or mixtures thereof, for example mixtures of silica and alumina. In the context of the present invention, each of the first, second and third washcoat may or may not, independently from one another, comprise a binder. If at least two or all three of the first, second and third washcoat comprise at least one binder, these washcoats may comprise the same or different binders.

In a preferred embodiment, the first, second and third washcoat all comprise at least one binder.

A washcoat which has been affixed to a catalyst carrier substrate is called a “coating”. It is also possible to affix two or more washcoats to the carrier substrate. The skilled person knows that affixing two or more washcoats onto one single carrier substrate is possible by “layering” or by “zoning”, and it is also possible to combine layering and zoning. In case of layering, the washcoats are affixed successively onto the carrier substrate, one after the other. The washcoat that is affixed first and thus in direct contact with the carrier substrate represents the “bottom layer”, and the washcoat that is affixed last it the “top layer”. In case of zoning, a first washcoat is affixed onto the carrier substrate from a first face side A of the carrier substrate towards the other face side B, but not over the entire length of the carrier substrate, but only to an endpoint which is between face sides A and B. Afterwards, a second washcoat is affixed onto the carrier, starting from face side B until an endpoint between face sides B and A. The endpoints of the first and the second washcoat need not be identical: if they are identical, then both washcoat zones are adjacent to one another. If, however, the endpoints of the two washcoat zones, which are both located between face sides A and B of the carrier substrate, are not identical, there can be a gap between the first and the second washcoat zone, or they can overlap. As mentioned above, layering and zoning can also be combined, if, for instance, one washcoat is applied over the entire length of the carrier substrate, and the other washcoat is only applied from one face side to an endpoint between both face sides.

In the context of the present invention, the “washcoat loading” is the mass of the catalytically active composition per volume of the carrier substrate.

The skilled person knows that washcoats are prepared in the form of suspensions and dispersions.

Suspensions and dispersions are heterogeneous mixtures comprising solid particles and a solvent. The solid particles do not dissolve, but get suspended throughout the bulk of the solvent, left floating around freely in the medium. If the solid particles have an average particle diameter of less than or equal to 1 μm, the mixture is called a dispersion; if the average particle diameter is larger than 1 μm, the mixture is called a suspension. Washcoats in the sense of the present invention comprise a solvent, usually water, and solvent particles represented by particles of one or more the catalytically active compositions, and optionally particles of at least one binder as described above. This mixture is often referred to as the “washcoat slurry”. The slurry is applied to the carrier substrate and subsequently dried to form the coating as described above. In the context of the present invention, the term “washcoat suspension” is used for mixtures of solvents, particles of one or more catalytically active compositions, and optionally particles of at least one binder, irrespective of the individual or average particle sizes. This means that in “washcoat suspensions” according to the present invention, the size of individual particles as well as the average particle size of the one or more catalytically active solid particles can be less than 1 μm, equal to 1 μm and/or larger than 1 μm.

The term “mixture” as used in the context of the present invention is a material made up of two of more different substances which are physically combined and in which each ingredient retains its own chemical properties and makeup. Despite the fact that there are no chemical changes to its constituents, the physical properties of a mixture, such as its melting point, may differ from those of the components.

A “catalyst”, also called “catalytic article” or “brick”, comprises of a catalyst carrier substrate and a washcoat, wherein the washcoat comprises a catalytically active composition and optionally at least one binder.

A “device” as used in the context of the present invention is a piece of equipment designed to serve a special purpose or perform a special function. The catalytic devices according to the present invention serve the purpose and have the function to remove both nitrogen oxides and ammonia from the exhaust gas of lean combustion engines. A “device” as used in the present invention may consist of one or more catalyst, also called “catalytic articles” or “bricks” as defined above.

The upstream SCR catalyst and the downstream ASC catalyst according to the present invention comprise, among other components, a first and a second SCR catalytically active composition SCR_{first} and SCR_{second}, respectively.

The first and the second SCR catalytically active composition SCR_{first} and SCR_{second}, respectively, can be selected, independently from one another, from molecular sieves.

A molecular sieve is a material with pores, i.e. with very small holes, of uniform size. These pore diameters are similar in size to small molecules, and thus large molecules cannot enter or be adsorbed, while smaller molecules can. In the context of the present invention, a molecular sieve can be zeolitic or non-zeolitic. Zeolites are made of corner-sharing tetrahedral SiO₄ and AlO₄ units. They are also called “silicoaluminates” or “aluminosilicates”. In the context of the present invention, these two terms are used synonymously.

As used herein, the terminology “non-zeolitic molecular sieve” refers to corner-sharing tetrahedral frameworks wherein at least a portion of the tetrahedral sites are occupied by an element other than silicon or aluminum. If a portion, but not all silicon atoms are replaced by phosphorous atoms, it deals with so-called “silico aluminophosphates” or “SAPOs”. If all silicon atoms are replaced by phosphorous, it deals with aluminophosphates or “AlPOs”.

A “zeolite framework type”, also referred to as “framework type”, represents the corner-sharing network of tetrahedrally coordinated atoms. It is common to classify zeolites according to their pore size which is defined by the ring size of the biggest pore aperture. Zeolites with a large pore size have a maximum ring size of 12 tetrahedral atoms, zeolites with a medium pore size have a maximum pore size of 10 and zeolites with a small pore size have a maximum pore size of 8 tetrahedral atoms. Well-known small-pore zeolites belong in particular to the AEI, CHA (chabazite), ERI (erionite), LEV (levyne), AFX and KFI framework. Examples having a large pore size are zeolites of the faujasite (FAU) framework type and zeolite Beta (BEA).

A “zeotype” comprises any of a family of materials based on the structure of a specific zeolite. Thus, a specific “zeotype” comprises, for instance, silicoaluminates, SAPOs and AlPOs that are based on the structure of a specific zeolite framework type. Thus, for example, chabazite (CHA), the silicoaluminates SSZ-13, Linde R and ZK-14, the silicoaluminophosphate SAPO-34 and the aluminophosphate MeAlPO-47 all belong to the chabazite framework type. The skilled person knows which silicoaluminates, silico aluminophosphates and aluminophosphates belong to the same zeotype. Furthermore, zeolitic and non-zeolitic molecular sieves belonging to the same zeotype are listed in the database of the International Zeolite Association (IZA). The skilled person can use this knowledge and the IZA database without departing from the scope of the claims.

In a preferred embodiment of the present invention, the molecular sieve is a small-pore crystalline aluminosilicate zeolite.

Suitable crystalline aluminosilicate zeolites are, for instance, zeolite framework type materials chosen from ACO, AEI, AEN, AFN, AFT, AFX, ANA, APC, APD, ATT, BEA, BIK, CDO, CHA, DDR, DFT, EAB, EDI, EPI, ERI, ESV, ETL, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and mixtures and intergrowths that contain at least one of these framework types. In a preferred embodiment of the present invention, the first and the second SCR catalytically active composition SCR_{first} and SCR_{second} are selected, independently from one another, from these molecular sieves.

In a more preferred embodiment of the present invention, the crystalline small-pore aluminosilicate zeolites have maximum pore size of eight tetrahedral atoms and are chosen from AEI, AFT, AFX, CHA, DDR, ERI, ESV, ETL, KFI, LEV, UFI and mixtures and intergrowths thereof. In an even more preferred embodiment, the zeolites are chosen from AEI, BEA, CHA, AFX and mixtures and intergrowths that contain at least one of these framework types. In a particularly preferred embodiment, the zeolite is AEI. In another particularly preferred embodiment, the zeolite is CHA.

An “intergrowth” of a zeolite comprises at least two different zeolite framework types or two different zeolite compositions of the same framework type.

In an “overgrowth” zeolite, one framework structure grows on top of the other one. Thus, “overgrowth” represents a species of “intergrowth”, and “intergrowth” is the genus.

In the present invention, zeolitic and non-zeolitic molecular sieves to be used as SCR catalysts or as a component of an SCR catalyst composition contain a transition metal. The transition metal is preferably selected from copper, iron and mixtures thereof.

Crystalline aluminosilicate zeolites to be used as SCR catalytically active compositions in the present invention have a silica-to-alumina ratio of 5 to 100, preferably 10 to 50. The silica-to-alumina ratio, SiO₂:Al₂O₃, is referred to hereinafter as “the SAR value” or “the SAR”.

Preferably, the crystalline aluminosilicate zeolites to be used as SCR catalytically active compositions in the present invention are promoted with a transition metal selected from copper, iron, or mixtures of copper and iron.

In one embodiment, the zeolites are promoted with copper. Preferably, the copper to aluminum atomic ratio is in the range of between 0.005 to 0.555, more preferably between 0.115 to 0.445, even more preferably between 0.175 and 0.415. The skilled person knows how to adjust the amount of copper which is introduced during synthesis or via ion exchange to yield the desired copper to aluminum ratio. He can make use of this knowledge without departing from the scope of the claims.

In another embodiment, the zeolites are promoted with iron. Preferably, the iron to aluminum atomic ratio is in the range of between 0.005 to 0.555, more preferably between 0.115 to 0.445, even more preferably between 0.175 and 0.415. The skilled person knows how to adjust the amount of iron which is introduced during synthesis or via ion exchange to yield the desired iron to aluminum ratio. He can make use of this knowledge without departing from the scope of the claims.

In yet another embodiment, the zeolites are promoted with both copper and iron. Preferably, the (Cu+Fe):Al atomic ratio is in the range of between 0.005 to 0.555, more preferably between 0.115 to 0.445, even more preferably between 0.175 and 0.415.

The upstream SCR catalyst according to the present invention comprises the first SCR catalytically active composition. Said first SCR catalytically active composition contains one or more molecular sieves. In embodiments wherein the first SCR catalytically active composition comprises two or more molecular sieves, the molecular sieves differ from one another in at least one of the following features:
they have different framework structures and/or
they belong to the same framework structure, but represent different zeotypes, and/or
they belong to the same framework type, but the first and the second compositions are selected from silicoaluminates and silico aluminophosphates, or silicoaluminates and aluminophosphates, or silico aluminophosphates and aluminophosphates, and/or
they are promoted with different transition metals, and/or
their transition metal amount is different, and/or
the silicoaluminates differ in their SAR values.

It is for instance possible to use an AEI and a CHA as the first and the second SCR catalytically active composition, wherein both zeolites are silicoaluminates, have the same SAR value and are promoted with the same amount of copper, because they differ in their framework structure. Furthermore, two CHA silicoaluminate zeolites or two AEI silicoaluminate zeolites are also considered “different” if they have different SAR values, or if they are promoted with different amounts of copper. In addition, two silicoaluminates having the CHA framework type are considered “different” if, for instance, one is SSZ-13 and the other one is ZK-14, even if they have the same SAR value and copper content, because they belong to different zeotypes.

The downstream ASC catalyst according to the present invention comprises the second SCR catalytically active composition. Said second SCR catalytically active composition contains one or more molecular sieves. In embodiments wherein the second SCR catalytically active composition comprises two or more molecular sieves, the molecular sieves differ from one another in at least one of the features as given above for the first SCR catalytically active composition.

In one embodiment of the present invention, the first and the second SCR catalytically active compositions are identical with regard to their physicochemical nature. Each of the first and the second SCR catalytically active composition may contain, independently from one another, one or more molecular sieves as described above. This means that SCR catalytically active compositions of the SCR catalyst and the ASC catalyst only differ with respect to their washcoat loading, and the ratio

$$\frac{{SCR}_{first}}{{SCR}_{second}}$$

of the loadings of the first and the second SCR catalytically active compositions, given in g/L, in the first and the second washcoat is 1.2:1 to 2:1 as mentioned above.

In another embodiment of the present invention, the first and the second SCR catalytically active compositions differ with regard to their physicochemical nature. Each of the first and the second SCR catalytically active composition may contain, independently from one another, one or more molecular sieves as described above. In this embodiment, the SCR catalytically active compositions of the SCR catalyst and the ASC catalyst differ in at least one of the following features:
at least one framework structure is only present in one the SCR catalytically active compositions, and/or
the molecular sieves in both SCR catalytically active compositions belong to the same framework structure, but represent different zeotypes, and/or
the molecular sieves in both SCR catalytically active compositions belong to the same framework type, but the first and the second compostions are selected from silicoaluminates and silico aluminophosphates, or silicoaluminates and aluminophosphates, or silico aluminophosphates and aluminophosphates, and/or
the molecular sieves in both SCR catalytically active compositions are promoted with different transition metals, and/or
their transition metal amount is different, and/or
the silicoaluminates differ in their SAR values.

In this embodiment, the ratio

$$\frac{{SCR}_{first}}{{SCR}_{second}}$$

of the loadings of the first and the second SCR catalytically active compositions, given in g/L, in the first and the second washcoat is also 1.2:1 to 2:1 as mentioned above.

The oxidation catalyst comprised in the third washcoat is a platinum group metal, a platinum group metal oxide, a mixture of two or more platinum group metals, a mixture of two or more platinum group metal oxides, or a mixture of at least one platinum group metal and at least one platinum group metal oxide. Platinum group metals, hereinafter abbreviated as PGM, are ruthenium, rhodium, palladium, osmium, iridium and platinum. In the present invention, PGM are selected from ruthenium, rhodium, palladium, iridium and platinum. The skilled person knows the respective oxides of these platinum group metal oxides and can apply them in the context of the present invention without departing from the scope of the claims. Preferably, the oxidation catalyst is a platinum group metal or a mixture of two or more platinum group metals. More preferably, the oxidation catalyst is selected from platinum and mixtures of platinum and palladium or platinum and rhodium.

The washcoat loading of the third washcoat is between 10 to 100 g/L, preferably 20 to 75 g/L. The PGM concentration within the washcoat is between 0.5 and 25 g/ft³, preferably between 1.5 and 10 g/ft³.

In preferred embodiments of the present invention, the first, second and third washcoat all comprise a binder. The binder can be selected from alumina, silica, non-zeolitic silica-alumina, naturally occurring clay, TiO₂, ZrO₂, CeO₂, SnO₂ and mixtures and combinations thereof. Preferably, the binder is selected from alumina, TiO₂, ZrO₂ and mixtures and combinations thereof. The binders of the first, second and third washcoat can be the same or different from one another.

It has surprisingly been found that the ratio

$$\frac{{SCR}_{first}}{{SCR}_{second}}$$

of the loadings of the first and the second SCR catalytically active compositions, given in g/L, in the first and the second washcoat has to be between 1.2:1 to 2:1, preferably larger than or equal to 1.3:1; even more preferably larger than or equal to 1.4 to 1. The upper limit of the

$$\frac{{SCR}_{first}}{{SCR}_{second}}$$

of the loadings of the first and the second SCR catalytically active compositions is preferably smaller than or equal to 1.6 to 1. Taken together, the ratio

$$\frac{{SCR}_{first}}{{SCR}_{second}}$$

of the loadings of the first and the second SCR catalytically active compositions, given in g/L, in the first and the second washcoat is preferably between 1.3:1 and 1.6:1; more preferably between 1.4:1 and 1.6:1.

Preferably, the washcoat loading of the first SCR catalytically active composition is between 100 and 230 g/L, preferably 140 to 200 g/L, and the washcoat loading of the second SCR catalytically active composition is between 70 and 170 g/L, preferably 90 to 140 g/L, under the proviso that the ratio

$$\frac{{SCR}_{first}}{{SCR}_{second}}$$

of the loadings of the first and second SCR catalytically active compositions, given in g/L, in the first and the second washcoat is between 1.2:1 to 2:1, with the preferred lower and upper limits of said range as described above.

The upstream SCR catalyst and the downstream ASC catalyst are present on a single carrier substrate or on two different carrier substrates.

In one embodiment, the single carrier substrate or the two different carrier substrates are selected from so-called flow-through substrates or wall-flow filters, respectively.

Both flow-through substrates and wall-flow filters may consist of inert materials, such as silicon carbide, aluminum titanate, cordierite or metal. Such carrier substrates are well-known to the skilled person and available on the market.

The skilled person knows that in the case of wall-flow filters, their average pore sizes and the mean particle size of the first SCR catalytically active composition and/or the mean particle size of the oxidation catalyst according to the present invention may be adjusted to one another in a manner that the coating thus obtained is located onto the porous walls which form the channels of the wall-flow filter (on-wall coating). However, the average pore sizes and the mean particle sizes of the first SCR catalytically active composition and/or the mean particle size of the oxidation catalyst are preferably adjusted to one another in a manner that the first SCR catalytically active composition and/or the oxidation catalyst according to the present invention is located within the porous walls which form the channels of the wall-flow filter. In this preferable embodiment, the inner surfaces of the pores are coated (in-wall coating). In this case, the mean particle size of the first SCR catalytically active composition and/or the oxidation catalyst according to the present invention has to be sufficiently small to be able to penetrate the pores of the wall-flow filter. The second washcoat comprising the second SCR catalytically active component is coated as a top layer after coating the oxidation layer, and is coated onto the bottom layer comprising the oxidation catalyst. If the particle size of the catalytically active composition of the second washcoat is small enough, the second washcoat will be coated in the wall. If the particle size of the catalytically active composition of the second washcoat is larger than the pores of the porous walls of the wall-flow filter, the second washcoat will be coated on the wall. If the oxidation layer and the second washcoat comprising the second SCR catalytically active component are coated as on wall layers onto the wall-flow filter, they are coated on the surface of the outlet channels.

In another embodiment, the carrier substrate is a corrugated catalysed substrate monolith. The substrate has a wall density of at least 50 g/l but not more than 300 g/l and a porosity of at least 50%. The substrate monolith is a paper of high silica content glass or a paper of E-glass fibre. The paper has a layer of diatomaceous earth or a layer of titania, and the catalyst is a zeolite according to the present invention. This corrugated substrate monolith has the advantage that the catalytic zeolite layer does not peel off from the monolithic substrate during start and stop of a combustion engine. The SCR catalytically active material is applied on a monolithic substrate, which has the form of plane or corrugated plates. The substrate is made from sheets of E-glass fibres or from sheets of a glass with high silicon content and with a layer of TiO₂ or diatomaceous earth. The high silicon content glass contains 94-95% by weight SiO₂, 4-5% by weight Al₂O₃ and some Na₂O, these fibres have a density of 2000-2200 g/l with a fibre diameter is 8-10 μm. An example is the commercially available SILEX staple fiber. The E-glass contains 52-56% by weight SiO₂, 12-16% by weight Al₂O₃, 5-10% by weight B₂O₃, 0-1.5% by weight TiO₂, 0-5% by weight MgO, 16-25% by weight CaO, 0-2% by weight K₂0/Na₂0 and 0-0.8% by weight Fe₂O₃. The material of the substrate is chosen in a manner that the density of the substrate is at least 50 g/l, but not higher than 300 g/l material, and the porosity of the substrate wall is at least 50% by volume of the material. The porosity of the monolithic substrate is obtained by the pores, which have a depth between 50 μm and 200 μm and a diameter between 1 μm and 30 μm. The SCR catalytically active material is applied on the substrate as a layer with a thickness of 10-150 μm. The SCR catalytically active material is a zeolite according to the present invention. The catalyst is applied by dipping the monolithic substrate into aqueous slurry of fine particles of zeolite, a binder and an anti-foam agent. The size of the particles is not more than 50 μm. The binder is preferably a silica sol binder, and the antifoam agent is a silicone antifoam agent. The coated substrate is dried and subsequently calcinated at 400-650° C., preferably 540-560° C., most preferably at 550° C. A catalyst element comprises layers of corrugated plates, which are separated from each other by plane plates. Catalyst elements can be in the form of boxes or cylinders. Corrugated substrate monoliths and their manufacture are disclosed in WO 2010/066345 A1, and the teaching thereof can be applied to the present invention without departing from the scope of the claims.

In one embodiment of the present invention, the upstream SCR catalyst and the downstream ASC catalyst are present as two adjacent zones on one single carrier substrate,
(a) wherein the upstream SCR catalyst extends on an axial length of the carrier substrate from the upstream end to 40 to 80% of the entire length of the carrier substrate, and
(b) wherein the downstream ASC catalyst extends on an axial length of the carrier substrate from the downstream end to 40 to 80% of the entire length of the carrier substrate.

In this embodiment of a zoned catalyst, the upstream SCR catalyst zone and the downstream ASC catalyst zone can be directly adjacent to one another without an overlap, or they can overlap, or there can be a gap between them. In case of a gap between the two zones, the length of the gap accounts for a maximum of 20% of the total axial length of the carrier. In case of adjacent zones, there is substantially no overlap nor a gap between the SCR catalyst zone and the ASC catalyst zone, and the lengths of both zones account for 100% of the total axial length of the carrier. In case of an overlap, the ASC catalyst zone overlaps the SCR catalyst zone. This means that the bottom layer of the ASC catalyst zone overlaps the SCR catalyst zone, which comprises a binder and the first SCR catalytically active composition SCR_{first}, and the bottom layer of the ASC catalyst is covered with the top layer comprising a second washcoat comprising a second binder and a second SCR catalytically active composition SCR_{second}.

In this embodiment wherein the upstream SCR catalyst and the downstream ASC catalyst are present as two adjacent zones on one single carrier substrate, the carrier substrate is selected from ceramic, metallic and corrugated carrier substrates as described above. Preferably, the carrier substrate is a ceramic substrate selected from flow-through substrates and wall-flow filters.

In another embodiment of the present invention, the upstream SCR catalyst and the downstream ASC catalyst are present on two different carrier substrates which are immediately adjacent to one another.

In this embodiment wherein the upstream SCR catalyst and the downstream ASC catalyst are present on two different carrier substrates, the carrier substrate is selected from ceramic, metallic and corrugated carrier substrates as described above. Preferably, the carrier substrate is a ceramic substrate selected from flow-through substrates and wall-flow filters.

The object to provide a system for the treatment of exhaust gases of lean-burn combustion engines which comprises the catalytic devices according to the present invention is solved by a system for the removal of nitrogen oxides and ammonia from the exhaust gas of lean-burn combustion engines, comprising:
(a) means for injecting ammonia or an ammonia precursor solution into the exhaust stream,
(b) a catalytic device according to the present invention arranged immediately downstream of the means for injecting ammonia or an ammonia precursor solution according to a).

The skilled person knows that the SCR reaction requires the presence of ammonia as a reductant. Ammonia may be supplied in an appropriate form, for instance in the form of liquid ammonia or in the form of an aqueous solution of an ammonia precursor, and added to the exhaust gas stream as needed via means for injecting ammonia or an ammonia precursor. Suitable ammonia precursors are, for instance urea, ammonium carbamate or ammonium formiate. A widespread method is to carry along an aqueous urea solution and to and to dose it into the catalyst according to the present invention via an upstream injector and a dosing unit as required. Means for injecting ammonia, for example an upstream injector and a dosing unit, are well known to the skilled person and can be used in the present invention without departing from the scope of the claims.

The present invention thus also refers to a system for the purification of exhaust gases emitted from lean combustion engines, characterized in that it comprises a catalyst according to the present invention, preferably in the form of a coating on a carrier substrate or as a component of a carrier substrate, and an injector for aqueous urea solutions, wherein the injector is located upstream of the catalyst of the present invention.

The system for the treatment of exhaust gases of lean-burn combustion engines which comprise the catalytic devices according to the present invention may further comprise an oxidation catalyst for the oxidation of volatile organic compounds, carbon monoxide and hydrocarbons, said catalyst being located directly upstream of the means for injecting ammonia or an ammonia precursor solution into the exhaust system according to a) above.

In another embodiment, the system for the treatment of exhaust gases of lean-burn combustion engines which comprise the catalytic devices according to the present invention may, in addition to the oxidation catalyst for the oxidation of volatile organic compounds, carbon monoxide and hydrocarbons, further comprise a filter for the removal of particulate matter, said filter being located immediately downstream of the oxidation catalyst and immediately upstream of the means for injecting ammonia or an ammonia precursor solution into the exhaust stream.

The systems for the removal of nitrogen oxides and ammonia from the exhaust gas of lean-burn combustion engines as disclosed above can furthermore be used for the aftertreatment of exhaust gases from lean-burn combustion engines.

The catalytic devices according to the present invention can be manufactured by processes known in the art. Powders of the SCR catalytically active compositions or the oxidation catalyst and optionally the at least one binder are mixed with water. Optionally, the mixture can be milled to adjust the particle sizes. The concentration of the solids in the respective washcoat is adjusted according to the desired washcoat loading. The washcoat is then applied onto the catalyst substrate in a direction perpendicular to the face sides A and B of the catalyst substrate. It can be applied top to bottom, preferably by applying the washcoat under pressure in the direction from the top face side to the bottom face side. Alternatively, the washcoat can be applied bottom to top, preferably by soaking it from the bottom face side to the top face side under reduced pressure. Subsequently, excess washcoat is removed either by sucking it out, preferably under reduced pressure, or by purging it out under pressure. Finally, the washcoated carrier substrate is dried and calcined in an oven. In case more than one washcoat shall be applied, the steps of preparing the respective washcoat slurry, applying it, removing excess washcoat, and drying and calcining are repeated. These processes are well known to the skilled person and can be applied in the context of the present invention without departing from the scope of the claims.

### BRIEF DESCRIPTION OF THE DRAWINGS

FIG. 1 shows the temperature, volumetric mass flow, NH₃, NO and NO₂ amount at the inlet of the SCR/ASC catalyst of Example 1 and Comparative Example 1 for the case of an α value of 1.4 according to Embodiment 1.

FIG. 2a shows the NH₃ conversion versus the α value of Example 1 and Comparative Example 1 as measured in the World Harmonized Transient Cycle (WHTC) according to Embodiment 1.

FIG. 2b shows the NOₓ conversion versus the α value of Example 1 and Comparative Example 1 as measured in the World Harmonized Transient Cycle (WHTC) according to Embodiment 1.

FIG. 3a shows the NH₃ conversion versus the α value of Comparative Example 1 and Comparative Example 2 as measured in the World Harmonized Transient Cycle (WHTC) according to Embodiment 1.

FIG. 3b shows the NOₓ conversion versus the α value of Comparative Example 1 and Comparative Example 2 as measured in the World Harmonized Transient Cycle (WHTC) according to Embodiment 1.

FIG. 4 shows the temperature, volumetric mass flow, NH₃, NO and NO₂ amount at the inlet of the SCR/ASC catalysts according to Example 1 and Comparative Example 1 as measured in the Federal Test Procedure (FTP) cycle according to Embodiment 2.

FIG. 5a shows the NH₃ conversion versus the α value of Example 1 and Comparative Example 1 as measured in the Federal Test Procedure (FTP) cycle according to Embodiment 2.

FIG. 5b shows the NOₓ conversion versus the α value of Example 1 and Comparative Example 1 as measured in the Federal Test Procedure (FTP) cycle according to Embodiment 2.

FIG. 6a shows the NH₃ slip of Example 1 and Comparative Example 1 in the temperature range of from 250 to 500° C. according to Embodiment 3.

FIG. 6b shows the NO slip of Example 1 and Comparative Example 1 in the temperature range of from 250 to 500° C. according to Embodiment 3.

FIG. 6c shows the N₂O formation of Example 1 and Comparative Example 1 in the temperature range of from 250 to 500° C. according to Embodiment 3.

FIG. 7a shows the NH₃ conversion versus the α value of Example 2 and Example 3 as measured in the World Harmonized Transient Cycle (WHTC) according to Embodiment 3.

FIG. 7b shows the NOₓ conversion versus the α value of Example 2 and Example 2 as measured in the World Harmonized Transient Cycle (WHTC) according to Embodiment 3.

FIG. 8a shows the NH₃ conversion versus the α value of Example 2 and Example 3 as measured in the Federal Test Procedure (FTP) cycle according to Embodiment 4.

FIG. 8b shows the NOₓ conversion versus the α value of Example 2 and Example 3 as measured in the Federal Test Procedure (FTP) cycle according to Embodiment 4.

FIG. 9a shows the NH₃ slip of Example 2 (dashed line) and Example 3 (continuous line) in the FDT test.

FIG. 9b shows the NO slip of Example 2 (dashed line) and Example 3 (continuous line) in the FDT test.

### EMBODIMENTS

### Example 1

A catalytic device according to the present invention is manufactured, wherein the SCR zone is located upstream, and the ASC zone is located downstream on the same carrier substrate. The carrier substrate is a cordierite flow-through carrier having a total length of 8 inches (20.32 cm) and a diameter of 10.5 inches (26.67 cm); 400, cpsi (cells per square inch), 4 mil.

SCR catalyst composition in the SCR part: 194 g/L of catalytically active material (Cu-CHA), SAR=13; 5.5 wt.-% of Cu, calculated as CuO and based on the total weight of the zeolite. Length of the SCR zone: 6 inches (15.24 cm)

ASC Part:
Oxidation catalyst: Pt particles supported on TiO₂, loading 25 g/L, 2 g/ft³ (0.0707 g/L) precious metal loading.
SCR catalyst: 135 g/L of catalytically active material (Cu-CHA), SAR=13; 5.5 wt.-% of Cu, calculated as CuO and based on the total weight of the zeolite.
Length of the ASC zone: 2 inches (5.08 cm).
The ratio SCR_{first}/SCR_{second} is 1.4.
The binder used for the SCR catalysts in both the SCR and the ASC zone is alumina.

### Comparative Example 1

A catalytic device is manufactured, wherein the SCR zone is located upstream, and the ASC zone is located downstream on the same carrier substrate. The carrier substrate is a cordierite flow-through carrier having a total length of 8 inches (20.32 cm) and a diameter of 10.5 inches (26.67 cm); 400, cpsi (cells per square inch), 4 mil. The loading of the SCR catalytically active substance in both the SCR and the ASC zone is identical.

SCR catalyst composition in the SCR part: 180 g/L of catalytically active material (Cu-CHA), SAR=13; 5.5 wt.-% of Cu, calculated as CuO and based on the total weight of the zeolite. Length of the SCR zone: 6 inches (15.24 cm)

ASC Part:
Oxidation catalyst: Pt particles supported on TiO₂, loading 25 g/L, 2 g/ft³ (0.0707 g/L) precious metal loading.
SCR catalyst: 180 g/L of catalytically active material (Cu-CHA), SAR=13; 5.5 wt.-% of Cu, calculated as CuO and based on the total weight of the zeolite.
The ratio SCR_{first}/SCR_{second} is 1.0.
The binder used for the SCR catalysts in both the SCR and the ASC zone is alumina.

### Comparative Example 2

A catalytic device is manufactured, wherein the SCR zone is located upstream, and the ASC zone is located downstream on the same carrier substrate. The carrier substrate is a cordierite flow-through carrier having a total length of 8 inches (20.32 cm) and a diameter of 10.5 inches (26.67 cm); 400, cpsi (cells per square inch), 4 mil. The loading of the SCR catalytically active substance in SCR zone is lower than that in the ASC zone.

SCR catalyst composition in the SCR part: 171 g/L of catalytically active material (Cu-CHA), SAR=13; 5.5 wt.-% of Cu, calculated as CuO and based on the total weight of the zeolite. Length of the SCR zone: 6 inches (15.24 cm)

ASC Part:
Oxidation catalyst: Pt particles supported on TiO₂, loading 25 g/L, 2 g/ft³ (0.0707 g/L) precious metal loading.
SCR catalyst: 207 g/L of catalytically active material (Cu-CHA), SAR=13; 5.5 wt.-% of Cu, calculated as CuO and based on the total weight of the zeolite.
The ratio SCR_{first}/SCR_{second} is 0.83.
The binder used for the SCR catalysts in both the SCR and the ASC zone is alumina.

### Embodiment 1

In this embodiment, the performance of Example 1, Comparative Example 1 and Comparative Example 2 are evaluated in a World Harmonized Transient Cycle (WHTC). Upstream the SCR/ASC catalysts a Diesel Oxidation Catalyst (DOC) and coated Diesel Particulate Filter (cDPF) are used.

Three consecutive WHTC cycles are carried out and the results of the third test are presented. The amount of NH₃ entering the SCR catalyst is adjusted based on the amount of NOx entering the SCR catalyst, such that the α value is changed from a value of 0.9-1.5, where the α value is the NH₃ concentration divided by the NOₓ concentration:

$$α = \frac{[ {NH}_{3} ]}{[ {NO}_{x} ]}$$

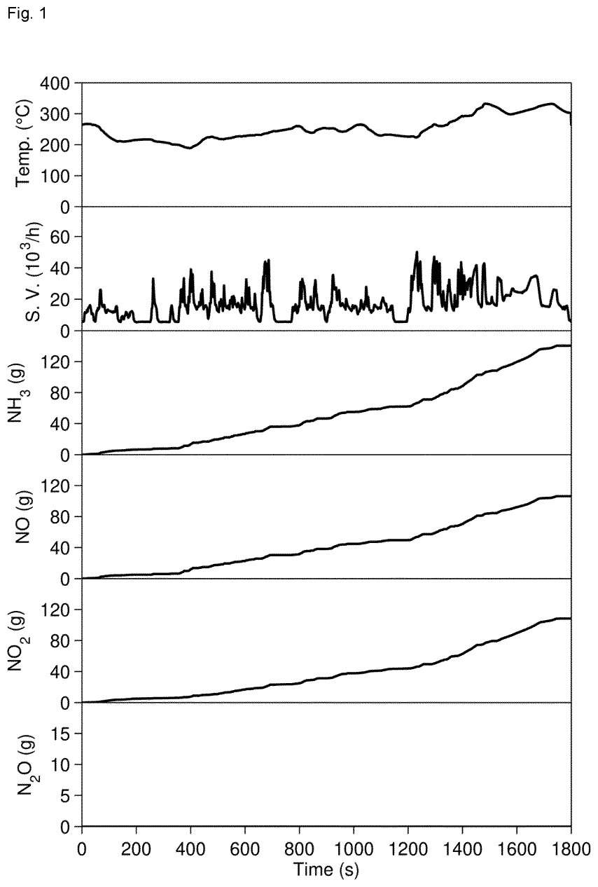

The temperature, volumetric mass flow, NH₃, NO and NO₂ amount at the inlet of the SCR/ASC catalyst are shown in FIG. 1 for the case of an α value of 1.4.

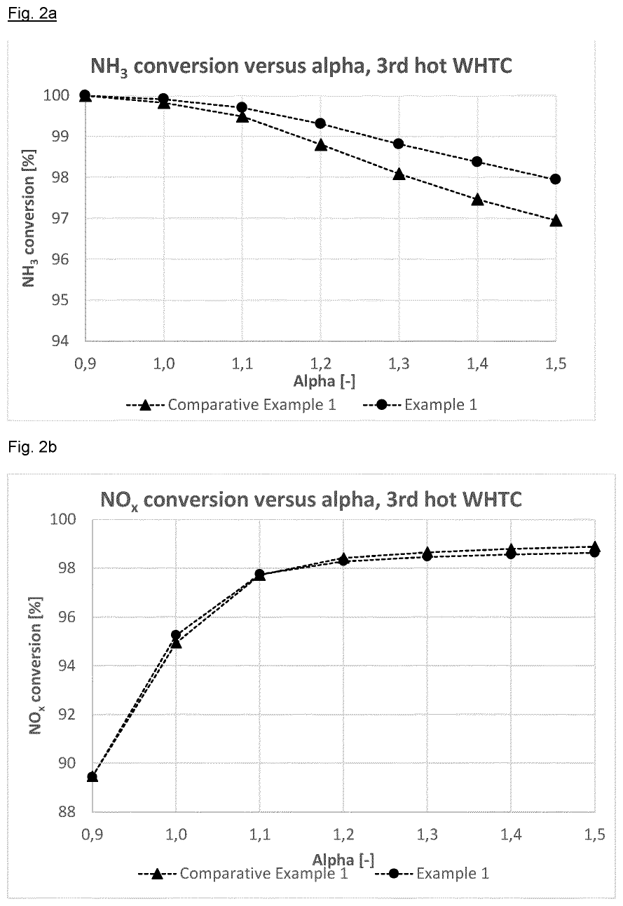

The NH₃ and NOₓ conversions of Example 1 and Comparative Example 1 for this embodiment are shown in Table 1 and FIGS. 2a and 2b.

Tab. 1 shows the NH₃ conversion and the NOₓ conversion versus alpha for Example 1 and Comparative Example 1 in Embodiment 1.

3rd Hot WHTC

| | Comparative Example 1 | | Example 1 | |
|---|---|---|---|---|
| | NH₃ Conv. | NOₓ Conv. | NH₃ Conv. | NOₓ Conv. |
| Alpha | (%) | (%) | (%) | (%) |
| 0.9 | 100.0 | 89.5 | 100.0 | 89.4 |
| 1.0 | 99.8 | 94.9 | 99.9 | 95.3 |
| 1.1 | 99.5 | 97.7 | 99.7 | 97.8 |
| 1.2 | 98.8 | 98.4 | 99.3 | 98.3 |
| 1.3 | 98.1 | 98.7 | 98.8 | 98.5 |
| 1.4 | 97.5 | 98.8 | 98.4 | 98.6 |
| 1.5 | 96.9 | 98.9 | 97.9 | 98.6 |

FIG. 2a shows the NH₃ conversion versus the α value. The washcoat loading of 150 g/L of the second washcoat of Example 1, compared to 200 g/L in the SCR layer of the ASC in Comparative Example 1, allows for a higher NH₃ conversion.

FIG. 2b shows the NOₓ conversion versus the α value. Due to the fact that more NH₃ is oxidized in the WHTC, the NOₓ conversion of Example 1 is slightly lower than that of Comparative Example 1.

Tab. 2 shows the NH₃ conversion and the NOₓ conversion versus alpha for Comparative Example 1 and Comparative Example 2 in Embodiment 1.

3rd Hot WHTC

| | Comparative Example 1 | | Comparative Example 2 | |
|---|---|---|---|---|
| | NH₃ Conv. | NOₓ Conv. | NH₃ Conv. | NOₓ Conv. |
| Alpha | (%) | (%) | (%) | (%) |
| 0.9 | 100.0 | 89.5 | 100.0 | 89.5 |
| 1.0 | 99.8 | 94.9 | 99.8 | 94.8 |
| 1.1 | 99.5 | 97.7 | 99.3 | 97.7 |
| 1.2 | 98.8 | 98.4 | 98.4 | 98.4 |
| 1.3 | 98.1 | 98.7 | 97.6 | 98.7 |
| 1.4 | 97.5 | 98.8 | 96.9 | 98.8 |
| 1.5 | 96.9 | 98.9 | 96.3 | 98.9 |

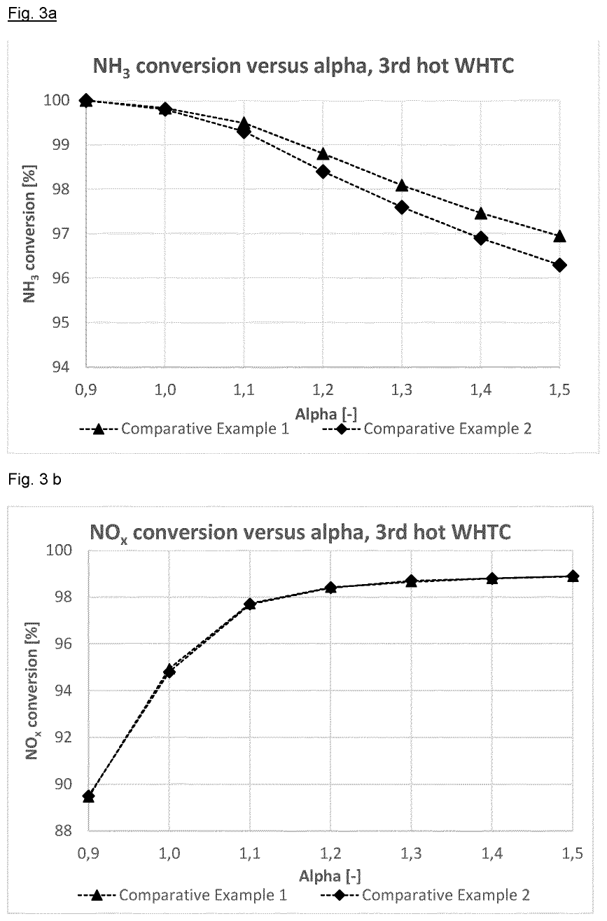

FIG. 3a shows the NH₃ conversion versus the α value. The washcoat loading of 230 g/L of the second washcoat of Comparative Example 2, compared to 200 g/L in the SCR layer of the ASC in Comparative Example 1, result in lower NH₃ conversion.

FIG. 3b shows the NOₓ conversion versus the α value. No differences are observed for between Comparative Example 1 and Comparative Example 2.

### Embodiment 2

In this embodiment, both catalyst configurations shown in Example 1 and Comparative Example 1 are evaluated during a Federal Test Procedure (FTP) cycle. Upstream the SCR/ASC catalysts a Diesel Oxidation Catalyst (DOC) and coated Diesel Particulate Filter (cDPF) are used.

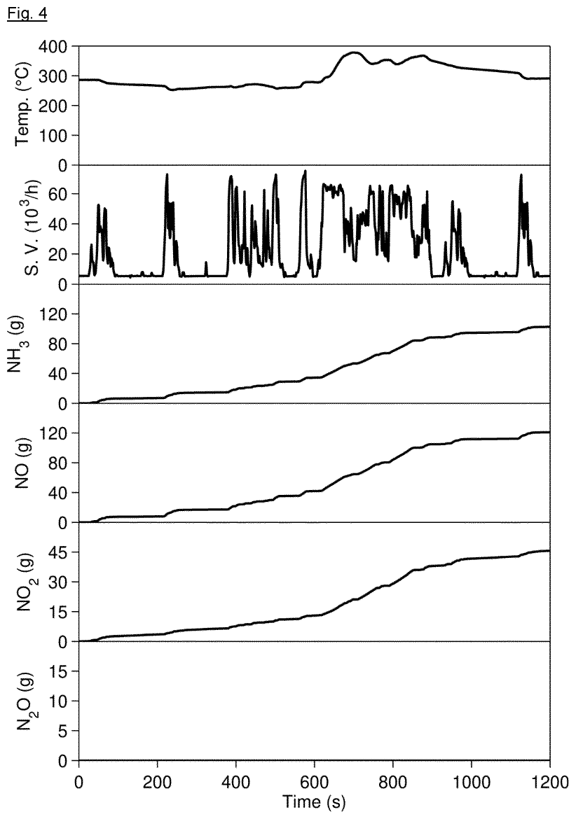

Three consecutive FTP cycles are carried out and the results of the third test are presented. The amount of NH₃ entering the SCR catalyst is adjusted based on the amount of NOₓ entering the SCR catalyst, such that the α value is changed from a value of 0.9-1.5, where the α value is defined as in Embodiment 1. The temperature, volumetric mass flow, NH₃, NO and NO₂ amount at the inlet of the SCR/ASC catalyst are shown in FIG. 4 for the case of an α value of 1.2.

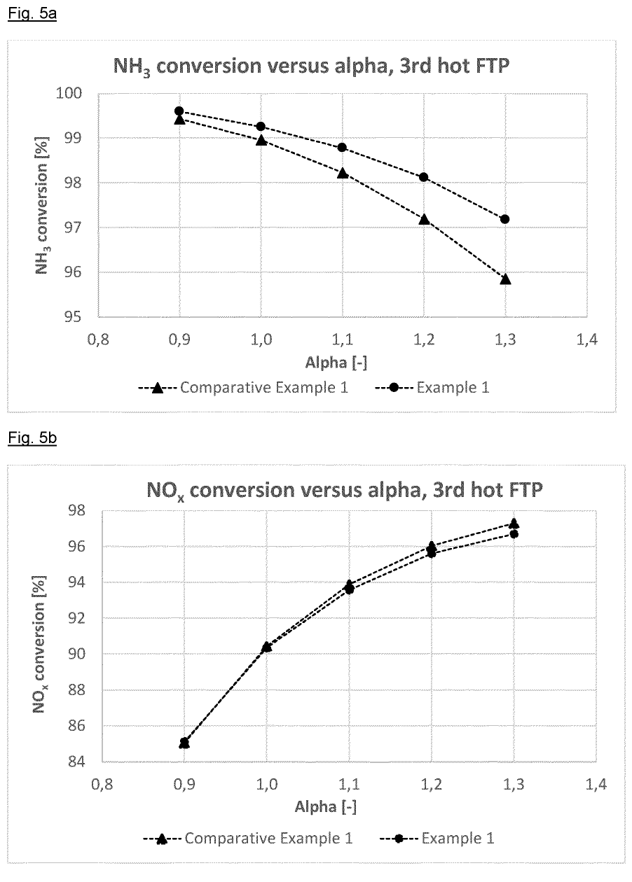

The NH₃ and NOₓ conversions of Example 1 and Comparative Example 1 for this embodiment are shown in Table 3 and FIG. 5.

Tab. 3 shows the NH₃ conversion and the NOₓ conversion versus alpha for Example 1 and Comparative Example 1 in Embodiment 2.

| | Comparative Example 1 | | Example 1 | |
|---|---|---|---|---|
| | NH3 Conv. | NOx Conv. | NH3 Conv. | NOx Conv. |
| Alpha | (%) | (%) | (%) | (%) |
| 0.9 | 99.4 | 85.1 | 99.6 | 85.1 |
| 1.0 | 99.0 | 90.4 | 99.3 | 90.4 |
| 1.1 | 98.2 | 93.9 | 98.8 | 93.6 |
| 1.2 | 97.2 | 96.0 | 98.1 | 95.6 |
| 1.3 | 95.9 | 97.3 | 97.2 | 96.7 |

FIG. 5a shows the NH₃ conversion versus the α value. The washcoat loading of 150 g/L of the second washcoat of Example 1, compared to 200 g/L in the SCR layer of the ASC in Comparative Example 1, allows for a higher NH₃ conversion.

FIG. 5b shows the NOₓ conversion versus the α value. Due to the fact that more NH₃ is oxidized in the FTP, the NOₓ conversion of Example 1 is slightly lower than that of Comparative Example 1.

### Embodiment 3

In this embodiment a feed of 750 ppm NH₃, 500 ppm NO, 5% O₂, 5% H₂O, and N₂ as the balance gas are passed across Example 1 and Comparative Example 1 until steady state was reached. The temperature during this time is held constant at 200° C. and the space velocity is 60000 h⁻¹. Once steady state is reached (i.e. no variation in the concentration of the measured gas species and temperature), the following feed modifications takes place simultaneously: NH₃ is removed from the feed, the space velocity is suddenly increased to 100000 h⁻¹, and the temperature is ramped to 500° C. at a rate of 250 K/min. This sudden change in feed conditions is done to mimic a change in load during real driving conditions, which stresses the SCR and ASC catalyst with NH₃ slip. This test is hereinafter referred to as the Fast Desorption Test (FDT).

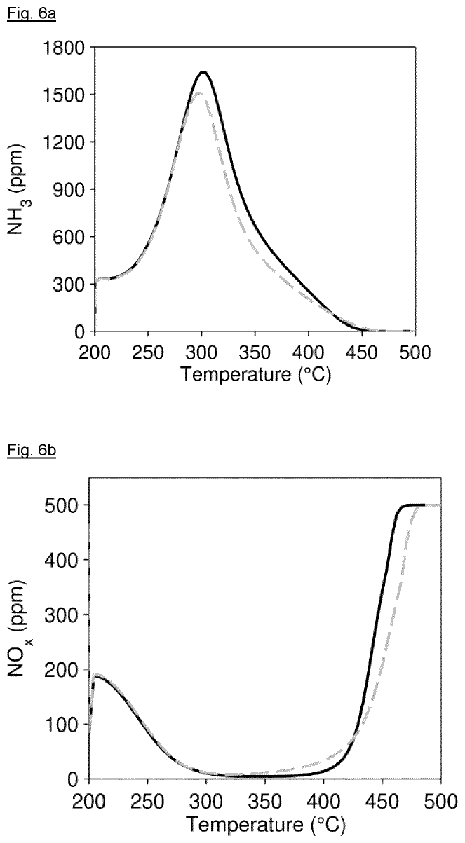

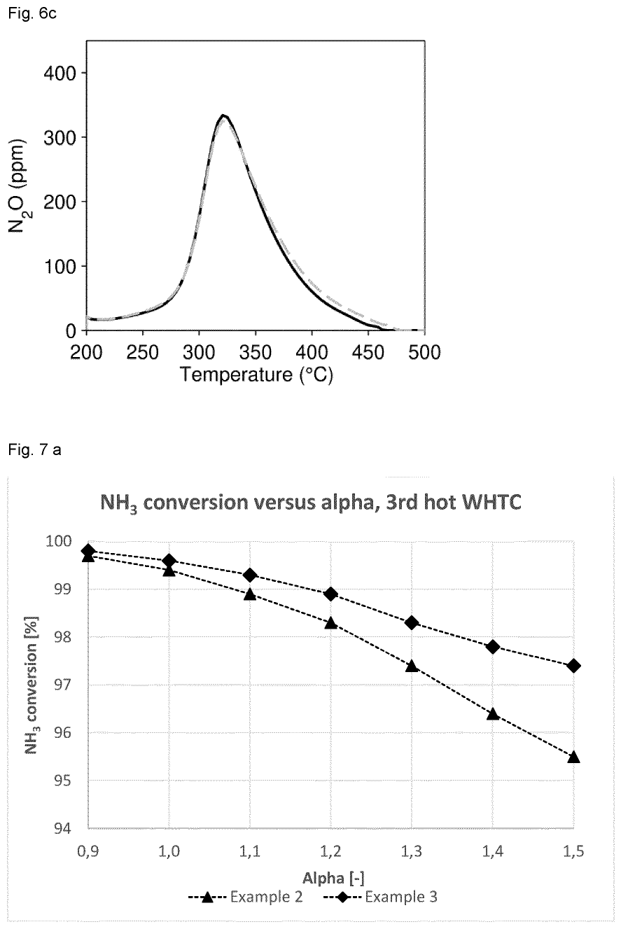

The NH₃ slip, NO slip, and N₂O formation across Example 1 (dotted line) and Comparative Example 1 (continuous line) during the temperature increase phase are shown in FIGS. 6a, 6b and 6c respectively. Here the benefit of Example 1 in decreasing NH₃ and NO slip compared to Comparative Example 1 can be seen.

### Example 2

A catalytic device according to the present invention is manufactured, wherein the SCR zone is located upstream, and the ASC zone is located downstream on the same carrier substrate. The carrier substrate is a cordierite flow-through carrier having a total length of 8 inches (20.32 cm) and a diameter of 10.5 inches (26.67 cm); 400, cpsi (cells per square inch), 4 mil.

SCR catalyst composition in the SCR part: 200 g/L of catalytically active material (CuCHA), SAR=13; 5.5 wt.-% of Cu, calculated as CuO and based on the total weight of the zeolite. Length of the SCR zone: 6 inches (15.24 cm)

ASC Part:
Oxidation catalyst: Pt particles supported on TiO₂, loading 25 g/L, 2 g/ft³ (0.0707 g/L) precious metal loading.
SCR catalyst: 125 g/L of catalytically active material (Cu-CHA), SAR=13; 5.5 wt.-% of Cu, calculated as CuO and based on the total weight of the zeolite.
Length of the ASC zone: 2 inches (5.08 cm).
The ratio SCR_{first}/SCR_{second} is 1.6.
The binder used for the SCR catalysts in both the SCR and the ASC zone is alumina.

### Example 3

A catalytic device according to the present invention is manufactured, wherein the SCR zone is located upstream, and the ASC zone is located downstream on the same carrier substrate. The carrier substrate is a cordierite flow-through carrier having a total length of 8 inches (20.32 cm) and a diameter of 10.5 inches (26.67 cm); 400, cpsi (cells per square inch), 4 mil.

SCR catalyst composition in the SCR part: 200 g/L of catalytically active material (CuCHA), SAR=13; 5.5 wt.-% of Cu, calculated as CuO and based on the total weight of the zeolite. Length of the SCR zone: 5 inches (12.7 cm)

ASC Part:
Oxidation catalyst: Pt particles supported on TiO₂, loading 25 g/L, 2 g/ft³ (0.0707 g/L) precious metal loading.
SCR catalyst: 150 g/L of catalytically active material (Cu-CHA), SAR=13; 5.5 wt.-% of Cu, calculated as CuO and based on the total weight of the zeolite.
Length of the ASC zone: 3 inches (7.62 cm).
The ratio SCR_{first}/SCR_{second} is 1.3.
The binder used for the SCR catalysts in both the SCR and the ASC zone is alumina.

### Embodiment 4

The performances of Examples 2 and 3 are evaluated in the WHTC cycle in the same manner as described in Embodiment 1.

Tab. 4 shows the NH₃ conversion and the NOₓ conversion versus alpha for Example 2 and Example 3 in Embodiment 4.

3rd Hot WHTC

| | Example 2 | | Example 3 | |
|---|---|---|---|---|
| | NH₃ Conv. | NOₓ Conv. | NH₃ Conv. | NOₓ Conv. |
| Alpha | (%) | (%) | (%) | (%) |
| 0.9 | 100.0 | 89.5 | 100.0 | 89.4 |
| 1.0 | 99.9 | 94.6 | 100.0 | 93.9 |
| 1.1 | 99.8 | 97.2 | 99.9 | 96.6 |
| 1.2 | 99.4 | 97.8 | 99.8 | 97.5 |
| 1.3 | 99.0 | 98.0 | 99.6 | 97.8 |
| 1.4 | 98.6 | 98.1 | 99.5 | 97.9 |
| 1.5 | 98.3 | 98.2 | 99.4 | 98.0 |

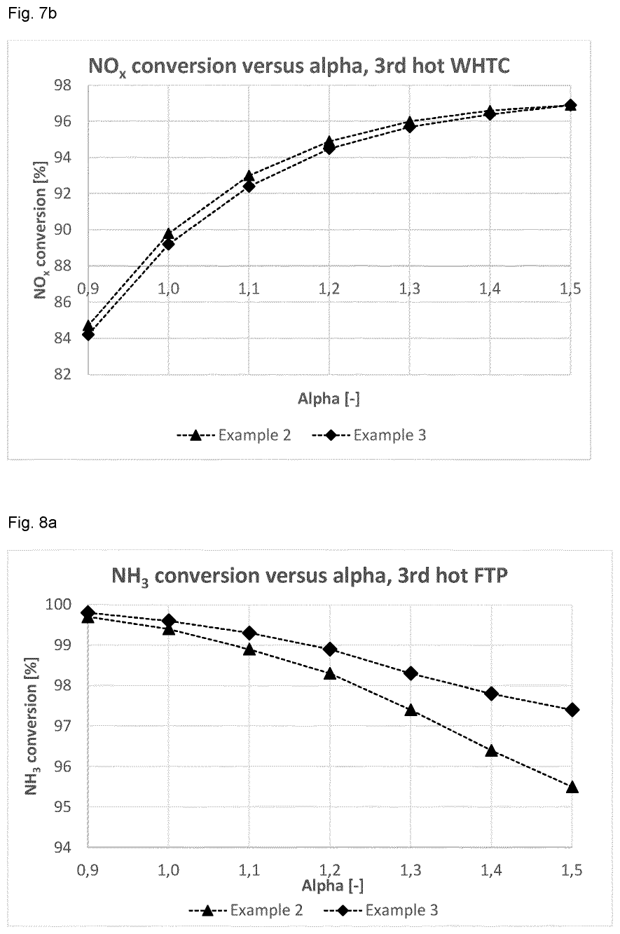

FIG. 7a shows the NH₃ conversion versus the α value. The washcoat loading of 150 g/L of the second washcoat of Example 2, compared to 125 g/L in the SCR layer of the ASC in Example 3, allows for a higher NH₃ conversion.

FIG. 7b shows the NOₓ conversion versus the α value. Due to the fact that more NH₃ is oxidized in the WHTC, the NOₓ conversion of Example 3 is slightly lower than that of Example 2.

The NH₃ and NOₓ conversions of Example 2 and Example 3 are shown in Table 4 and FIGS. 7a and 7b.

### Embodiment 5

The performances of Examples 2 and 3 are evaluated in the FTP cycle in the same manner as described in Embodiment 2.

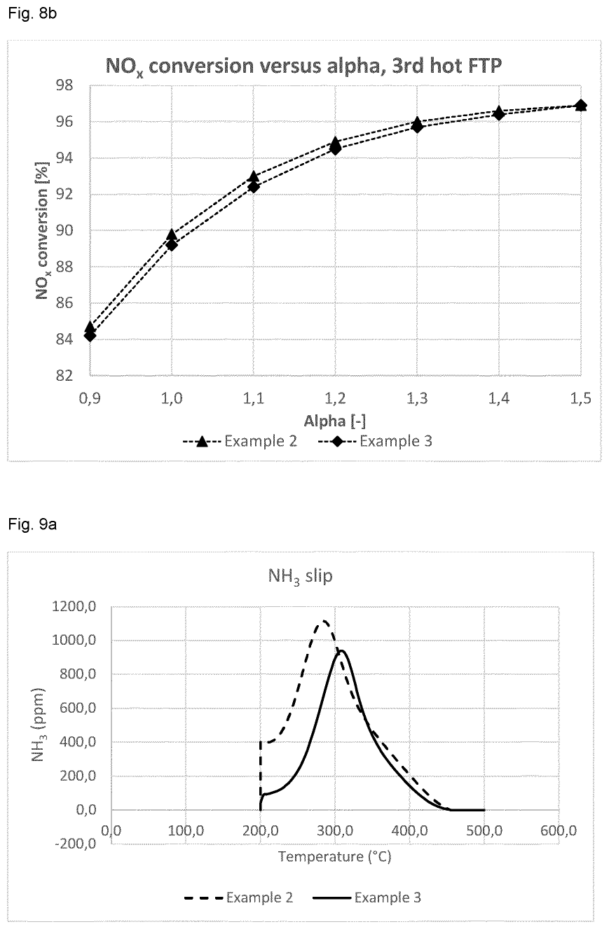

The NH₃ and NOₓ conversions of Example 2 and Example 3 are shown in Table 5 and FIGS. 8a and 8b.

Tab. 5 shows the NH₃ conversion and the NOₓ conversion versus alpha for Example 1 and Example 2 in Embodiment 4.

| | Example 2 | | Example 3 | |
|---|---|---|---|---|
| | NH3 Conv. | NOx Conv. | NH3 Conv. | NOx Conv. |
| Alpha | (%) | (%) | (%) | (%) |
| 0.9 | 99.7 | 84.7 | 99.8 | 84.2 |
| 1.0 | 99.4 | 89.8 | 99.6 | 89.2 |
| 1.1 | 98.9 | 93.0 | 99.3 | 92.4 |
| 1.2 | 98.3 | 94.9 | 98.9 | 94.5 |
| 1.3 | 97.4 | 96.0 | 98.3 | 95.7 |
| 1.4 | 96.4 | 96.6 | 97.8 | 96.4 |
| 1.5 | 95.5 | 96.9 | 97.4 | 96.9 |

FIG. 8a shows the NH₃ conversion versus the α value. The washcoat loading of 150 g/L of the second washcoat of Example 3, compared to 125 g/L in the SCR layer of the ASC in Example 2, allows for a higher NH₃ conversion.

FIG. 8b shows the NOₓ conversion versus the α value. Due to the fact that more NH₃ is oxidized in the FTP, the NOₓ conversion of Example 3 is slightly lower than that of Example 2.

### Embodiment 6

An FDT test is performed with Examples 2 and 3 in the same manner as described in Embodiment 3.

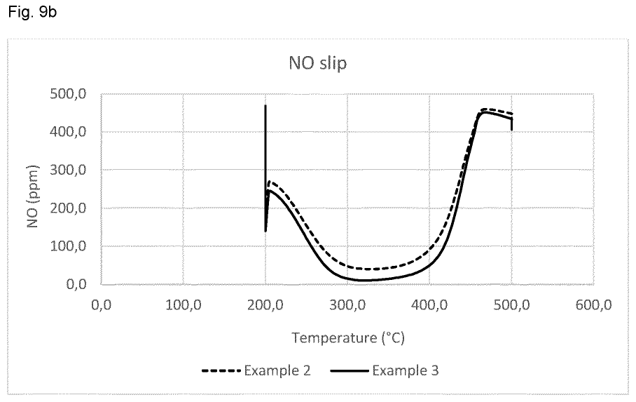

FIG. 9a shows the NH₃ slip of Example 2 (dashed line) and Example 3 (continuous line). The washcoat loading of 150 g/L of the second washcoat of Example 3, compared to 125 g/L in the SCR layer of the ASC in Example 2, allows for a lower ammonia slip.

FIG. 9b shows the NO slip of Example 2 (dashed line) and Example 3 (continuous line). The washcoat loading of 150 g/L of the second washcoat of Example 3, compared to 125 g/L in the SCR layer of the ASC in Example 2, allows for a lower NO slip.

1-21. (canceled)

22. A catalytic device for the removal of nitrogen oxides and ammonia from the exhaust gas of lean-burn combustion engines, comprising:
a) an upstream SCR catalyst comprising
i) a carrier substrate, and
ii) a first washcoat comprising a first SCR catalytically active composition SCR_{first} and optionally at least one first binder, wherein the first washcoat is applied to the carrier substrate,
b) a downstream ASC catalyst comprising
i) a carrier substrate, and
ii) a bottom layer comprising a third washcoat comprising an oxidation catalyst and optionally at least one third binder, said bottom layer being applied directly onto the carrier substrate, and
iii) a top layer comprising a second washcoat comprising a second SCR catalytically active composition SCR_{second} and optionally at least one second binder and, said top layer being applied onto the bottom layer,
wherein
the upstream SCR catalyst and the downstream ASC catalyst are present on a single carrier substrate or on two different carrier substrates,
the first and the second SCR catalytically active compositions are the same or different from one another,
the optionally comprised at least one first, second and third binders are the same or different from one another, and
the ratio
$$\frac{{SCR}_{first}}{{SCR}_{second}}$$
of the loadings of the first and the second SCR catalytically active compositions, given in g/L, in the first and the second washcoat is 1.2:1 to 2:1.

23. The catalytic device according to claim 22, wherein the first and the second SCR catalytically active composition are, independently from one another, selected from molecular sieves.

24. The catalytic device according to claim 23, wherein the molecular sieves are crystalline aluminosilicate zeolites selected from ACO, AEI, AEN, AFN, AFT, AFX, ANA, APC, APD, ATT, BEA, BIK, CDO, CHA, DDR, DFT, EAB, EDI, EPI, ERI, ESV, ETL, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and mixtures and intergrowths that contain at least one of these framework types.

25. The catalytic device according to claim 24, wherein the crystalline aluminosilicate zeolites have a SAR value of 5 to 100.

26. The catalytic device according to claim 24, wherein the crystalline aluminosilicate zeolites are promoted with copper, and wherein the copper to aluminum atomic ratio is in the range of between 0.005 to 0.555.

27. The catalytic device according to claim 24, wherein the aluminosilicate zeolites are promoted with iron, and wherein the iron to aluminum atomic ratio is in the range of between 0.005 to 0.555.

28. The catalytic device according to claim 24, wherein the aluminosilicate zeolites are promoted with both copper and iron, and wherein the (Cu+Fe):Al atomic ratio is in the range of between 0.005 to 0.555.

29. The catalytic device according to claim 22, wherein the oxidation catalyst comprises a platinum group metal, a platinum group metal oxide, a mixture of two or more platinum group metals, a mixture of two or more platinum group metal oxides, or a mixture of at least one platinum group metal and at least one platinum group metal oxide, wherein the platinum group metal is selected from ruthenium, rhodium, palladium, iridium and platinum.

30. The catalytic device according to claim 22, wherein the first, second and third binder are, independently from one another, selected from alumina, silica, non-zeolitic silica-alumina, naturally occurring clay, TiO₂, ZrO₂, CeO₂, SnO₂ and mixtures and combinations thereof.

31. The catalytic device according to claim 22, wherein the washcoat loading of the first SCR catalytically active composition is between 100 and 230 g/L, and the washcoat loading of the second SCR catalytically active composition is between 70 and 170 g/L, under the proviso that the ratio
$$\frac{{SCR}_{first}}{{SCR}_{second}}$$
of the loadings of the first and the second SCR catalytically active compositions, given in g/L, in the first and the second washcoat is between 1.2:1 to 2:1.

32. The catalytic device according to claim 22, wherein the washcoat loading of the third washcoat is between 10 and 100 g/L, and the platinum group metal concentration within the third washcoat is between 0.5 and 25 g/ft³.

33. The catalytic device according to claim 22, wherein
the upstream SCR catalyst and the downstream ASC catalyst are present as two adjacent zones on one single carrier substrate,
the upstream SCR catalyst extends on an axial length of the carrier substrate from the upstream end to 40 to 80% of the entire length of the carrier substrate,
the downstream ASC catalyst extends on an axial length of the carrier substrate from the downstream end to 40 to 80% of the entire length of the carrier substrate, and
there is substantially no overlap nor a gap between the SCR catalyst zone and the ASC catalyst zone, and the lengths of both zones account for 100% of the total axial length of the carrier.

34. The catalytic device according to claim 33, wherein the carrier substrate is selected from ceramic, metallic and corrugated carrier substrates.

35. The catalytic device according to claim 34, wherein the carrier substrate is a ceramic carrier substrate selected from flow-through carrier substrates and wall-flow filters.

36. The catalytic device according to claim 22, wherein the upstream SCR catalyst and the downstream ASC catalyst are present on two different carrier substrates which are immediately adjacent to one another.

37. The catalytic device according to claim 36, wherein the carrier substrates are, independently from one another, selected from ceramic, metallic and corrugated carrier substrates.

38. The catalytic device according to claim 37, wherein the carrier substrates are ceramic carrier substrate which are selected, independently from one another, from flowthrough carrier substrates and wall-flow filters.

39. A system for the removal of nitrogen oxides and ammonia from the exhaust gas of lean-burn combustion engines, comprising:
a) means for injecting ammonia or an ammonia precursor solution into the exhaust stream,
b) a catalytic device according to claim 22 arranged immediately downstream of the means for injecting ammonia or an ammonia precursor solution according to a).

40. The system for the removal of nitrogen oxides and ammonia from the exhaust gas of lean-burn combustion engines according to claim 39, further comprising an oxidation catalyst for the oxidation of volatile organic compounds, carbon monoxide and hydrocarbons, said catalyst being located directly upstream of the means for injecting ammonia or an ammonia precursor solution into the exhaust system.

41. The system for the removal of nitrogen oxides and ammonia from the exhaust gas of lean-burn combustion engines according to claim 39, further comprising a filter for the removal of particulate matter, said filter being located immediately downstream of the oxidation catalyst and immediately upstream of the means for injecting ammonia or an ammonia precursor solution into the exhaust stream.

42. A method of removing nitrogen oxides and ammonia from an exhaust gas of a lean-burn combustion engine, which comprises passing the exhaust gas through the catalytic device according to claim 22.
